(19) United States
(12) Patent Application Publication
(10) Pub. No.: US 2025/0091400 A1
(43) Pub. Date: Mar. 20, 2025

(54) SHOCK ABSORBER HAVING QUICK RELEASE TILTED ANGLE ADJUSTING DEVICE

(71) Applicant: YI-FAN CHEN, TAICHUNG CITY (TW)

(72) Inventor: YI-FAN CHEN, TAICHUNG CITY (TW)

(21) Appl. No.: 18/587,108

(22) Filed: Feb. 26, 2024

(30) Foreign Application Priority Data
Sep. 14, 2023 (TW) 112209956

(51) Int. Cl. B60G 13/00

(52) U.S. Cl. CPC B60G 13/005

(57) ABSTRACT

A shock absorber includes a quick release tilted angle adjusting device including an adjusting seat with a first elongated groove and two second elongated grooves, a base unit with an axle in the first elongated groove and two threaded hole groups corresponding to the second elongated grooves respectively, and two quick release assemblies each including a quick release handle, a threaded pillar in the second elongated groove and the threaded hole group, and a pressing seat sleeved onto the threaded pillar for being tightly abutted on the adjusting seat by the quick release handle at a tightly press position. When the quick release handle is at a release position, the threaded pillar is rotatable by the user to enable the adjusting seat and the base unit to be relatively moved. The shock absorber is adjustable in tilted angle thereof conveniently and fast and prevented from making abnormal noise.

### BACKGROUND OF THE INVENTION

### 1. Field of the Invention

The present invention relates generally to shock absorbers of vehicle suspension systems and more particularly, to a shock absorber having a quick release tilted angle adjusting device.

### 2. Description of the Related Art

The current car modification market is quite mature. For consumers, adjusting the length of the shock absorber to adjust the height of the car body is a quite important need, and meanwhile a deflection angle of the shock absorber is usually also adjusted for adjusting a deflection angle of the wheel. Referring to Taiwan Patent No. M367830, the conventional shock absorber includes a top coupler provided with fastening bolts whose fastening positions can be adjusted by the user frontward and backward for adjusting the angle at which the central axis of the shock absorber is tilted backward, i.e. the caster angle. Besides, the top coupler is also provided with fastening bolts whose fastening positions can be adjusted by the user to the left and to the right for adjusting the angle at which the central axis of the shock absorber is tilted outward, so as to adjust the camber angle of the wheel. Adjusting the caster angle can correct the alignment for the running vehicle, so as to improve the stability of the vehicle running in a straight line. Adjusting the camber angles of the wheels can make the wheels tilted outward from top to bottom to make the bottoms of the wheels farther distanced from each other than the tops of the wheels, making the car relatively more stable while running.

However, the above-described conventional tilted angle adjusting structure of the shock absorber has relatively more components, and the adjusting process requires the use of a tool to adjust the fastening positions of many fastening bolts, so the adjusting manner is inconvenient and time-consuming. Besides, the fastening bolts are possible to loosen when the vehicle is running, causing the vehicle to make abnormal noise.

### SUMMARY OF THE INVENTION

The present invention has been accomplished in view of the above-noted circumstances. It is an objective of the present invention to provide a shock absorber having a quick release tilted angle adjusting device, which is adjustable in tilted angle thereof conveniently and fast, and the quick release tilted angle adjusting device is uneasy to loosen, which prevents the vehicle from making abnormal noise.

To attain the above objective, the present invention provides a shock absorber which includes a threaded rod, and a quick release tilted angle adjusting device disposed at an end of the threaded rod. The quick release tilted angle adjusting device includes a base unit, an adjusting seat, and two quick release assemblies. The base unit includes a top abutted surface, an axle protruding out of the top abutted surface, and two threaded hole groups provided on the top abutted surface and located by two sides of the axle respectively. Each of the threaded hole groups includes a plurality of threaded holes arranged in a straight line along an adjusting axis. The adjusting seat is disposed on the top abutted surface of the base unit. The adjusting seat includes an upper surface, a lower surface, and a first elongated groove and two second elongated grooves, which penetrate through the upper surface and the lower surface. The second elongated grooves are located by two sides of the first elongated groove respectively. The axle of the base unit is inserted through the first elongated groove. The second elongated grooves are located correspondingly to the threaded hole groups respectively. Each of the quick release assemblies includes a quick release handle, a threaded pillar pivotably connected with the quick release handle, and a pressing seat sleeved onto the threaded pillar. The threaded pillars of the two quick release assemblies are inserted through the two second elongated grooves respectively, and screwed into the threaded holes of the two threaded hole groups respectively. Each of the pressing seats is located on the upper surface of the adjusting seat. The quick release handle is pivotable relative to the threaded pillar and the pressing seat between a tightly press position and a release position. When the quick release handle is located at the tightly press position, the pressing seat is tightly abutted on the upper surface of the adjusting seat by the quick release handle. When the quick release handle is located at the release position, the threaded pillar is able to be rotated to be separated from the threaded hole. When the threaded pillars of the two quick release assemblies are separated from the threaded holes of the two threaded hole groups, the adjusting seat and the base unit are movable relative to each other in a way that the axle is relatively moved in the first elongated groove along the adjusting axis.

As a result, the adjusting seat is located at an end of the shock absorber and adapted to be connected to the vehicle chassis, and the other end of the shock absorber is adapted to be connected to the wheel axle. Therefore, moving the adjusting seat and the base unit relative to each other can adjust the tilted angle of the shock absorber on a specific axis, such as the caster angle or the camber angle. When the user wants to adjust the aforementioned tilted angle, the user can only use the hand thereof to pivot the quick release handle to the release position, and then the user can rotate the threaded pillar to separate it from the threaded hole of the base unit. After that, the user can move the adjusting seat and the base unit relative to each other to adjust the aforementioned tilted angle. After the adjustment, as long as the user fixedly screws the threaded pillars of the two quick release assemblies into the threaded holes of the two threaded hole groups and then pivots the quick release handles to the tightly press position, the quick release assemblies and the adjusting seat are fastened to the top abutted surface of the base unit firmly. Such adjusting manner requires no use of a tool and no rotating of many bolts, so the tilted angle can be adjusted conveniently and fast. Besides, the quick release assemblies are great in fastening effect and uneasy to loosen, which can prevent the vehicle from making abnormal noise.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is an assembled perspective view of a shock absorber having a quick release tilted angle adjusting device according to a first preferred embodiment of the present invention.

FIG. 2 is a partially enlarged view of FIG. 1.

FIG. 3 is a partially exploded perspective view of the shock absorber according to the first preferred embodiment of the present invention.

FIG. 4 and FIG. 5 are sectional views taken along the line 4-4 and the line 5-5 in FIG. 2 respectively.

FIG. 6 is an exploded perspective view of a quick release assembly of the shock absorber according to the first preferred embodiment of the present invention.

FIG. 7 is similar to FIG. 5, but they are different in the position of a quick release handle of the quick release assembly.

FIG. 8 is a partially assembled perspective view of a shock absorber having a quick release tilted angle adjusting device according to a second preferred embodiment of the present invention.

FIG. 9 is similar to FIG. 8, but they are different in the position of quick release handles of two quick release assemblies of the shock absorber.

FIG. 10 is an assembled perspective view of the quick release assembly of the shock absorber according to the second preferred embodiment of the present invention.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention. It should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

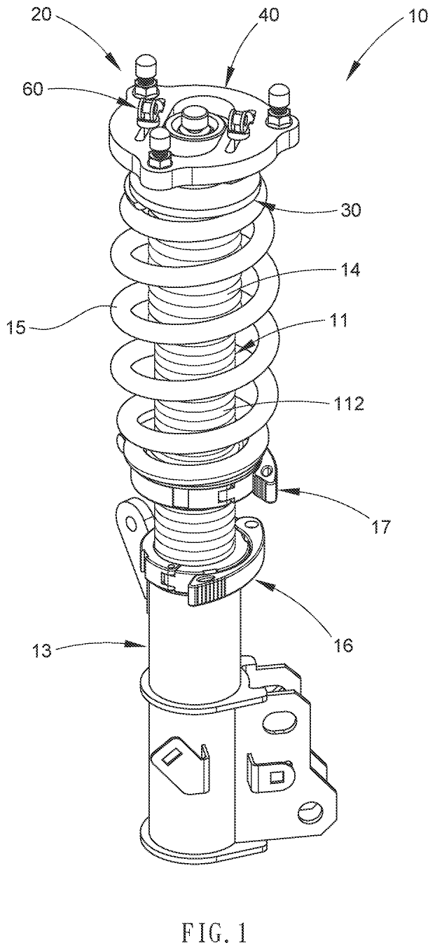

Referring to FIG. 1, a shock absorber 10 according to a first preferred embodiment of the present invention includes a threaded rod 11, a bottom seat 13 screwed onto the lower end of the threaded rod 11, a pipe 14 and a spring 15 sleeved onto the threaded rod 11, two fastening devices 16 and 17 screwed onto the threaded rod 11 for fastening the position of the bottom seat 13 and the position of the lower end of the spring 15 respectively, and a quick release tilted angle adjusting device 20 disposed at the upper end of the threaded rod 11.

The threaded rod 11 actually not only includes a threaded portion 112 screwed into the bottom seat 13 and the fastening devices 16 and 17, but also includes a central axle (not shown). The quick release tilted angle adjusting device 20 is disposed on the central axle. The pipe 14 is disposed at the bottom of the quick release tilted angle adjusting device 20 and covers the central axle. The technical features of the present invention primarily lie in the quick release tilted angle adjusting device 20. Other components are relatively less related to the technical features of the present invention, thereby not described in detail hereinafter.

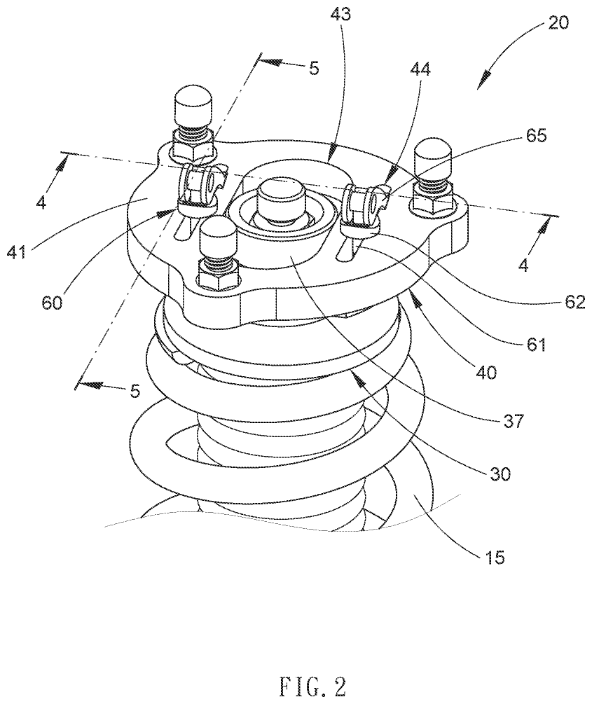

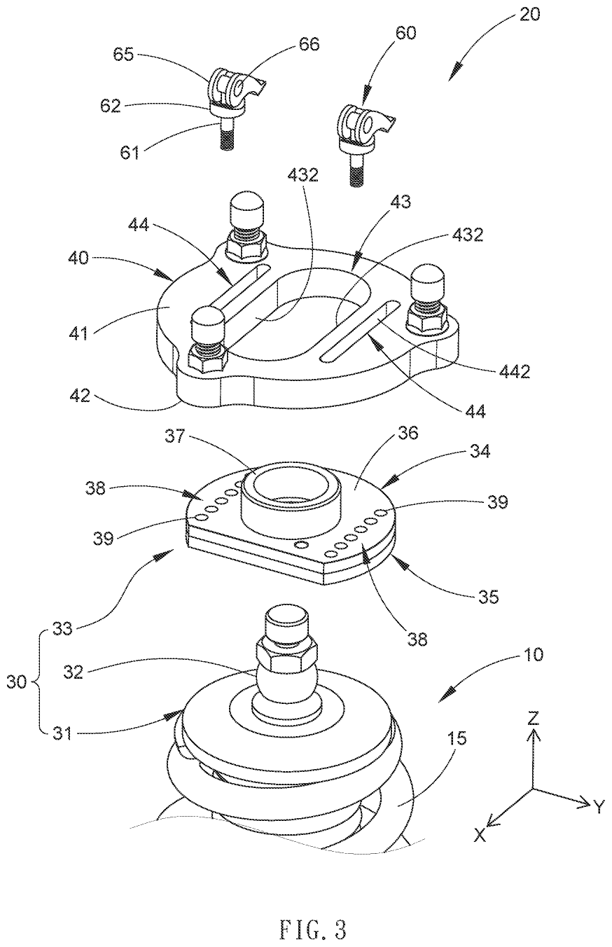

Referring to FIG. 2 and FIG. 3, the quick release tilted angle adjusting device 20 in this embodiment includes a base unit 30, an adjusting seat 40, and two quick release assemblies 60.

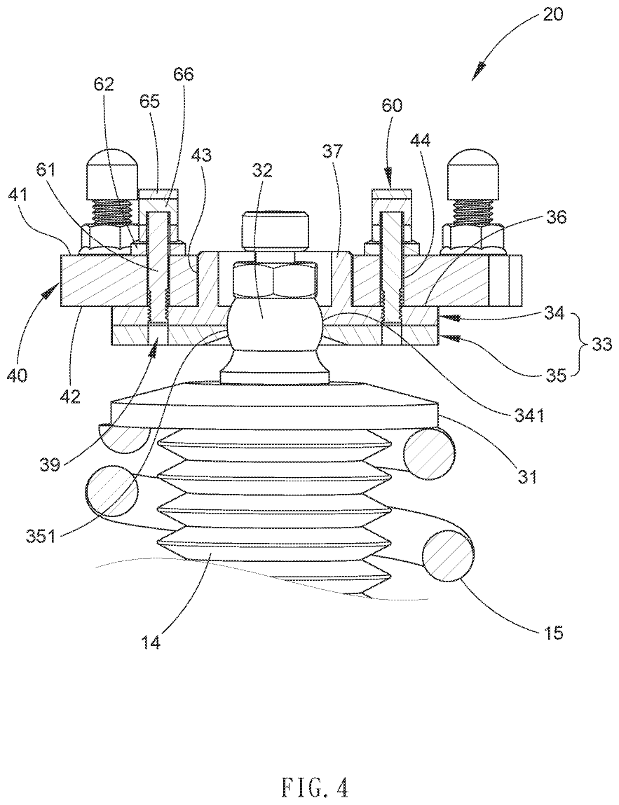

The base unit 30 includes a base 31, a spherical bearing 32, and a connecting seat 33. The base 31 is fixed to the central axle of the threaded rod 11. The upper end of the aforementioned spring 15 is abutted against the bottom of the base 31. The spherical bearing 32 is disposed on the base 31, and also fixed to the central axle. The connecting seat 33 is coupled with the spherical bearing 32, so that the connecting seat 33 is deflectable relative to the base 31 through the spherical bearing 32. Specifically speaking, the connecting seat 33 in this embodiment includes an upper board 34 and a lower board 35 as shown in FIG. 4, which are fastened to each other by bolts. The upper board 34 and the lower board 35 have a through hole 341 and a through hole 351 respectively. The through holes 341 and 351 of the upper board 34 and the lower board 35 are collectively coupled with the spherical bearing 32. As shown in FIG. 3, the connecting seat 33 includes a top abutted surface 36 located on the upper board 34, an axle 37 protruding out of the top abutted surface 36, and two threaded hole groups 38 provided on the top abutted surface 36 and located by two sides of the axle 37 respectively. Each threaded hole group 38 includes six threaded holes 39 arranged in a straight line along an adjusting axis (the X-axis shown in FIG. 3).

The adjusting seat 40 is shaped as a flat board, and includes an upper surface 41, a lower surface 42, and a first elongated groove 43 and two second elongated grooves 44, which penetrate through the upper surface 41 and the lower surface 42. The second elongated grooves 44 are located by two sides of the first elongated groove 43 respectively. The first elongated groove 43 has two opposite inner wall surfaces 432 extending along the aforementioned adjusting axis to have an elongated shape. The second elongated groove 44 has two opposite inner wall surfaces 442 extending along the aforementioned adjusting axis to have an elongated shape. The adjusting seat 40 is disposed on the top abutted surface 36 of the base unit 30 in a way that the lower surface 42 of the adjusting seat 40 is abutted on the top abutted surface 36 of the base unit 30, the axle 37 of the base unit 30 is inserted through the first elongated groove 43 of the adjusting seat 40, and the second elongated grooves 44 are located correspondingly to the threaded hole groups 38 respectively.

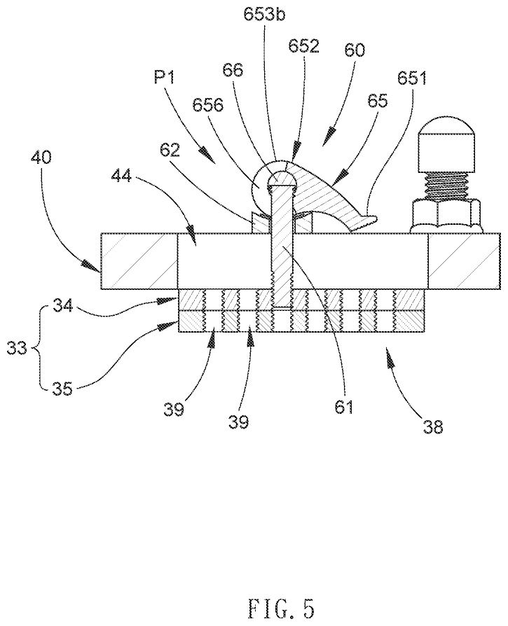

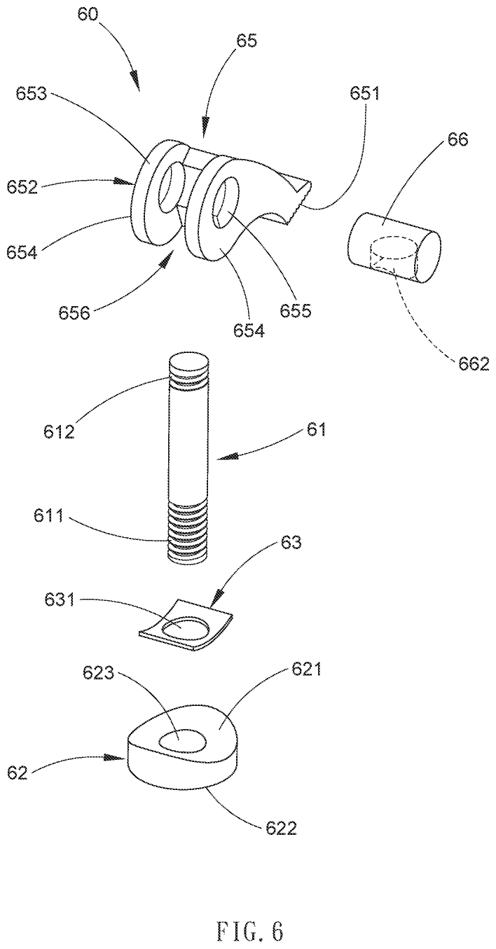

Referring to FIG. 5 and FIG. 6, the quick release assembly 60 includes a threaded pillar 61, a pressing seat 62 and an arc washer 63, which are sleeved onto the threaded pillar 61, a quick release handle 65, and a pivot 66 making the threaded pillar 61 and the quick release handle 65 pivotably connected with each other.

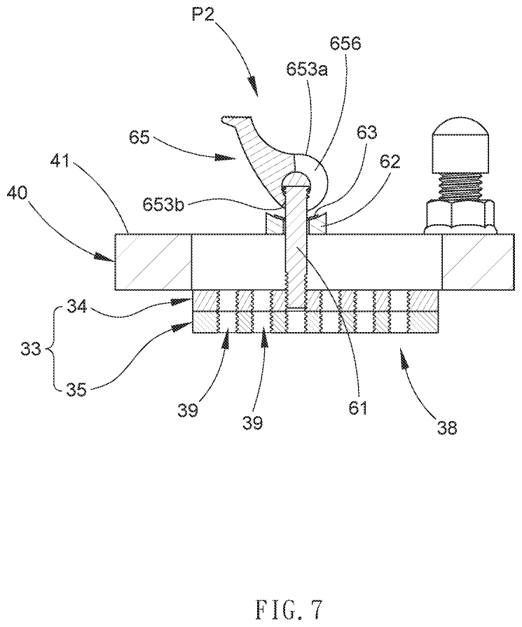

The quick release handle 65 has a hold end portion 651 and a pivotably connected end portion 652. The pivotably connected end portion 652 includes a convex arc surface 653, two lateral surfaces 654 located at two edges of the convex arc surface 653 respectively, and a pivot hole 655 penetrating through the two lateral surfaces 654. The pivot 66 is inserted through the pivot hole 655, and the pivot 66 has a fastening hole 662. Besides, the pivot hole 655 and the pivot 66 are eccentric with respect to the convex arc surface 653, so the convex arc surface 653 includes an abutting section 653a and a non-abutting section 653b, as shown in FIG. 7. The non-abutting section 653b is located closer to the pivot 66 than the abutting section 653a. Besides, the convex arc surface 653 further has an open groove 656 extending from the abutting section 653a to the non-abutting section 653b. The open groove 656 communicates with the pivot hole 655.

The pressing seat 62 includes a concave arc surface 621, a lower surface 622 opposite to the concave arc surface 621, and a through hole 623 penetrating through the concave arc surface 621 and the lower surface 622. The arc washer 63 is disposed on the concave arc surface 621 of the pressing seat 62 and approximately fit the concave arc surface 621. The arc washer 63 has another through hole 631 communicating with the through hole 623 of the pressing seat 62. The threaded pillar 61 is provided at two ends thereof with threaded sections 611 and 612 respectively. The threaded pillar 61 is inserted through the through hole 623 of the pressing seat 62 and the through hole 631 of the arc washer 63. The threaded section 612 is inserted into the open groove 656 of the quick release handle 65 and fixedly screwed into the fastening hole 662 of the pivot 66. In this way, the arc washer 63 is disposed between the convex arc surface 653 of the pivotably connected end portion 652 of the quick release handle 65 and the concave arc surface 621 of the pressing seat 62.

The threaded pillars 61 of the two quick release assemblies 60 are inserted through the two second elongated grooves 44 respectively, and the threaded sections 611 are screwed into the threaded holes 39 of the two threaded hole groups 38 respectively, making the lower surfaces 622 of the pressing seats 62 abutted on the upper surface 41 of the adjusting seat 40. The quick release handle 65 is pivotable relative to the threaded pillar 61, the pressing seat 62 and the arc washer 63 between a tightly press position P1 as shown in FIG. 5 and a release position P2 as shown in FIG. 7. When the quick release handle 65 is located at the tightly press position P1, the abutting section 653a of the convex arc surface 653 of the pivotably connected end portion 652 is indirectly abutted on the concave arc surface 621 of the pressing seat 62 through the arc washer 63, or there may be no such arc washer 63 and the abutting section 653a is directly abutted on the concave arc surface 621, so that the pressing seat 62 is tightly abutted on the upper surface 41 of the adjusting seat 40 and meanwhile the quick release assembly 60 and the adjusting seat 40 are fastened to the top abutted surface 36 of the base unit 30 firmly. When the quick release handle 65 is located at the release position P2, the non-abutting section 653b of the convex arc surface 653 of the pivotably connected end portion 652 faces toward the concave arc surface 621 of the pressing seat 62. At this time, the pressing seat 62 is not tightly abutted on the upper surface 41 of the adjusting seat 40 by the pivotably connected end portion 652 of the quick release handle 65. The user can hold the hold end portion 651 of the quick release handle 65 to rotate the quick release assembly 60, so as to separate the threaded pillar 61 from the threaded hole 39.

It can be known from the above description that when the user wants to adjust the tilted angle of the shock absorber 10, the user can only use the hand thereof to pivot the quick release handle 65 to the release position P2, and then the user can hold the hold end portion 651 of the quick release handle 65 to rotate the quick release assembly 60 to separate the threaded pillar 61 from the threaded hole 39 of the base unit 30. When the threaded pillars 61 of the two quick release assemblies 60 are separated from the threaded holes 39 of the two threaded hole groups 38, the adjusting seat 40 is not pressed by the pressing seat 62, and meanwhile the adjusting seat 40 and the base unit 30 are movable relative to each other in a way that the axle 37 is relatively moved along the inner wall surfaces 432 of the first elongated groove 43, which means the adjusting seat 40 and the base unit 30 are movable relative to each other along the aforementioned adjusting axis. The adjusting seat 40 is adapted to be connected to the vehicle chassis, and the bottom seat 13 of the shock absorber 10 is adapted to be connected to the wheel axle. Therefore, moving the adjusting seat 40 and the base unit 30 relative to each other can adjust the tilted angle of the shock absorber 10 on a specific axis, such as the caster angle or the camber angle. After the adjustment, as long as the user fixedly screws the threaded pillars 61 of the two quick release assemblies 60 into the threaded holes 39 of the two threaded hole groups 38 at appropriate positions again and then pivots the quick release handles 65 to the tightly press position P1, the quick release assemblies 60 and the adjusting seat 40 are fastened to the top abutted surface 36 of the base unit 30 firmly.

In the present invention, the quick release tilted angle adjusting device 20 of the shock absorber 10 has simple structure, and the adjusting process requires only the hand for operation, requiring no additional tool and requiring no rotating of many bolts. Therefore, the tilted angle can be adjusted conveniently and fast. Besides, the quick release assemblies 60 are great in fastening effect and uneasy to loosen, which can prevent the vehicle from making abnormal noise.

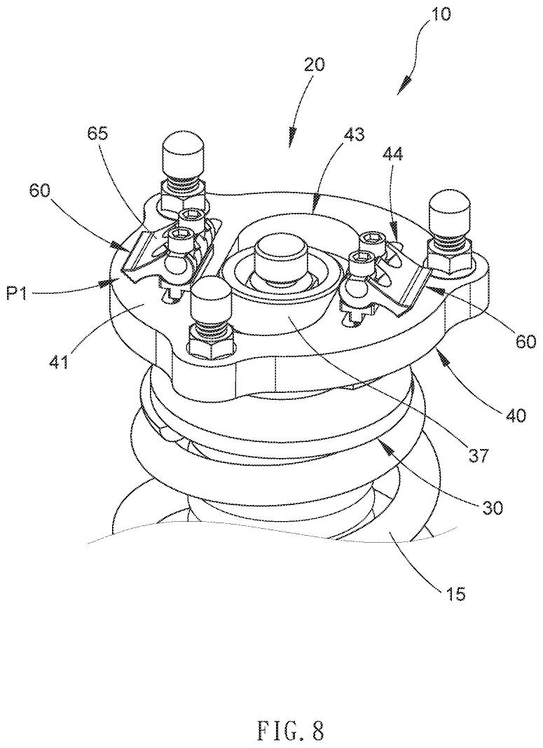

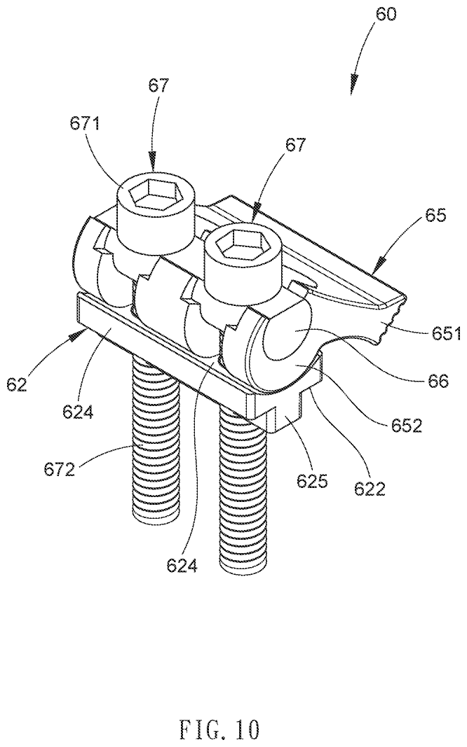

Referring to FIG. 8 to FIG. 10, the shock absorber 10 according to a second preferred embodiment of the present invention is similar to the shock absorber 10 in the first preferred embodiment, but the difference therebetween lies in the quick release assembly 60.

The quick release assembly 60 in this embodiment also includes a quick release handle 65, a pivot 66, and a pressing seat 62. The quick release handle 65 has a hold end portion 651 and a pivotably connected end portion 652, which are similar to those illustrated in the first preferred embodiment but relatively larger in width. The pivot 66 is inserted through the pivotably connected end portion 652 of the quick release handle 65. The most primary difference between the quick release assembly 60 in this embodiment and that in the first preferred embodiment lies in that the quick release assembly 60 in this embodiment includes two bolts 67. Each bolt 67 includes a bolt head 671 and a threaded pillar 672 connected with each other. The threaded pillar 672 is inserted through the pivot 66 and the pressing seat 62. In other words, each quick release assembly 60 includes two threaded pillars 672 pivotably connected with the quick release handle 65. The pressing seat 62 is sleeved onto the two threaded pillars 672.

Besides, the pressing seat 62 in this embodiment includes a base portion 624 and a protruding portion 625. The base portion 624 includes such concave arc surface 621 and lower surface 622 as illustrated in the first preferred embodiment. The protruding portion 625 protrudes from the lower surface 622 of the base portion 624. The base portion 624 is located on the upper surface 41 of the adjusting seat 40. The protruding portion 625 is inserted into the second elongated groove 44, so that two threaded pillars 672 of the same quick release assembly 60 are inserted through the same second elongated groove 44 and respectively screwed into two threaded holes 39 of the same threaded hole group 38 (as shown in FIG. 3).

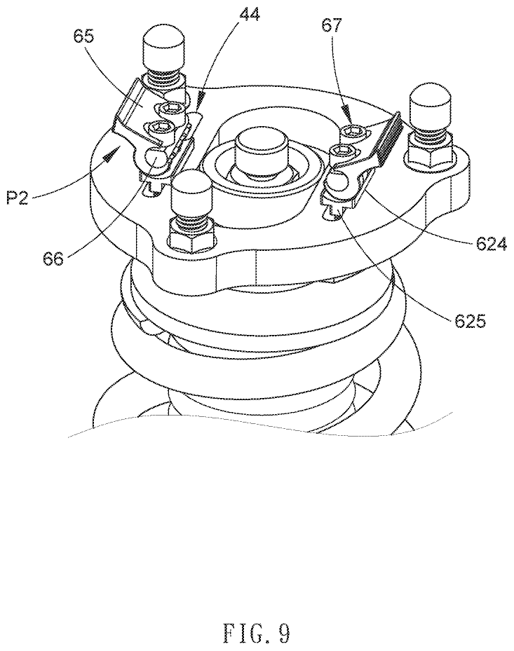

As a result, the quick release handle 65 in this embodiment is also pivotable relative to the threaded pillars 672 and the pressing seat 62 between a tightly press position P1 as shown in FIG. 8 and a release position P2 as shown in FIG. 9, thereby attaining the same effects as described in the first preferred embodiment. Furthermore, in this embodiment, two bolts 67 are included in the same quick release assembly 60, and the quick release handle 65 and the pressing seat 62 are correspondingly provided with relatively larger widths. Such configuration design can fasten the adjusting seat 40 on the top abutted surface 36 (as shown in FIG. 3) of the base unit 30 even more firmly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A shock absorber comprising:
a threaded rod; and
a quick release tilted angle adjusting device disposed at an end of the threaded rod, the quick release tilted angle adjusting device comprising:
a base unit comprising a top abutted surface, an axle protruding out of the top abutted surface, and two threaded hole groups provided on the top abutted surface and located by two sides of the axle respectively, each of the threaded hole groups comprising a plurality of threaded holes arranged in a straight line along an adjusting axis;
an adjusting seat disposed on the top abutted surface of the base unit, the adjusting seat comprising an upper surface, a lower surface, and a first elongated groove and two second elongated grooves, which penetrate through the upper surface and the lower surface, the two second elongated grooves being located by two sides of the first elongated groove respectively, the axle of the base unit being inserted through the first elongated groove, the two second elongated grooves being located correspondingly to the two threaded hole groups respectively; and
two quick release assemblies, each of the quick release assemblies comprising a quick release handle, a threaded pillar pivotably connected with the quick release handle, and a pressing seat sleeved onto the threaded pillar, the threaded pillars of the two quick release assemblies being inserted through the two second elongated grooves respectively and screwed into the threaded holes of the two threaded hole groups respectively, each of the pressing seats being located on the upper surface of the adjusting seat, the quick release handle being pivotable relative to the threaded pillar and the pressing seat between a tightly press position and a release position, when the quick release handle is located at the tightly press position, the pressing seat being tightly abutted on the upper surface of the adjusting seat by the quick release handle, when the quick release handle is located at the release position, the threaded pillar being able to be rotated to be separated from the threaded hole, when the threaded pillars of the two quick release assemblies are separated from the threaded holes of the two threaded hole groups, the adjusting seat and the base unit being movable relative to each other in a way that the axle is relatively moved in the first elongated groove along the adjusting axis.

2. The shock absorber as claimed in claim 1, wherein the quick release handle comprises a pivotably connected end portion and a hold end portion; the pivotably connected end portion comprises a pivot hole, and an open groove communicating with the pivot hole; a pivot is inserted in the pivot hole; an end of the threaded pillar is inserted into the open groove and fastened to the pivot.

3. The shock absorber as claimed in claim 2, wherein the pressing seat comprises a concave arc surface; the pivotably connected end portion of the quick release handle comprises a convex arc surface; the convex arc surface comprises an abutting section and a non-abutting section; the non-abutting section is located closer to the pivot than the abutting section; when the quick release handle is located at the tightly press position, the abutting section of the convex arc surface is directly or indirectly abutted on the concave arc surface of the pressing seat; when the quick release handle is located at the release position, the non-abutting section of the convex arc surface faces toward the concave arc surface of the pressing seat.

4. The shock absorber as claimed in claim 3, wherein each of the quick release assemblies further comprises an arc washer; the arc washer is disposed between the convex arc surface of the pivotably connected end portion of the quick release handle and the concave arc surface of the pressing seat; the threaded pillar is inserted through the arc washer; when the quick release handle is located at the tightly press position, the abutting section of the convex arc surface is indirectly abutted on the concave arc surface of the pressing seat through the arc washer.

5. The shock absorber as claimed in claim 1, wherein the base unit comprises a base fixed to the threaded rod, a spherical bearing disposed on the base, and a connecting seat coupled with the spherical bearing and thereby deflectable relative to the base; the connecting seat comprises the top abutted surface, the axle and the two threaded hole groups.

6. The shock absorber as claimed in claim 5, wherein the connecting seat comprises an upper board and a lower board, which are fastened to each other; the top abutted surface and the axle are located on the upper board; each of the upper board and the lower board has a through hole; the through holes of the upper board and the lower board are collectively coupled with the spherical bearing.

7. The shock absorber as claimed in claim 1, wherein each of the quick release assemblies comprises a pivot inserted in the quick release handle, and two bolts; each of the bolts comprises a bolt head and a said threaded pillar, which are connected with each other; the threaded pillars of the two bolts are inserted through the pivot and the pressing seat.

8. The shock absorber as claimed in claim 7, wherein the pressing seat comprises a base portion, and a protruding portion protruding from the base portion; the base portion is located on the upper surface of the adjusting seat; the protruding portion is located in the second elongated groove.
